(19) United States
(12) Patent Application Publication
(10) Pub. No.: US 2023/0417438 A1
(43) Pub. Date: Dec. 28, 2023

(54) BI-LEVEL OPTIMIZATION SCHEDULING METHOD FOR AIR CONDITIONING SYSTEM BASED ON DEMAND RESPONSE

(71) Applicant: Tianjin University, Tianjin (CN)

(72) Inventors: Yan DING, Tianjin (CN); Luheng LIU, Tianjin (CN); Chen HUANG, Tianjin (CN); Qiaochu WANG, Tianjin (CN)

(21) Appl. No.: 18/126,452

(22) Filed: Mar. 26, 2023

(30) Foreign Application Priority Data
Jun. 28, 2022 (CN) 2022107437964

(51) Int. Cl. F24F 11/47; F24F 11/64

(52) U.S. Cl. CPC F24F 11/47; F24F 11/64; F24F 2110/10

(57) ABSTRACT

A bi-level optimization scheduling method for an air conditioning system based on demand response includes: constructing a lumped heat capacity model to describe a heat storage capacity of a building to thereby obtain a building heat storage model; obtaining a function relational expression of describing an indoor dry bulb temperature and a cooling and heating load of the building based on the building heat storage model; constructing a power consumption calculation model under a working condition of demand response based on the function relational expression; constructing optimization objective functions based on the power consumption calculation model; and substituting the optimization objective functions into a bi-level optimization process, and optimizing the bi-level optimization process to obtain an optimal scheduling strategy for the air conditioning system participating in demand response. The method can achieve a global optimization of demand response scheduling strategy, and improve economy and energy saving of system operation.

### TECHNICAL FIELD

The disclosure relates to the field of computing, and particularly to a bi-level optimization scheduling method for an air conditioning system based on demand response.

### BACKGROUND

With increasing problems of energy shortage and environmental pollution, efficient and sustainable green energy usage has become a main theme of the current social development. Until the year 2025, there is a prediction that “proportion of non-fossil energy consumption will reach about 20%, a total installed capacity of wind power generation and solar power generation will reach more than 1.2 billion kilowatts”. However, since sustainable energy sources such as the wind generated power and the solar energy generated power have obvious intermittency and fluctuation in time, so that when the above described energy sources are connected to a power grid, there will be significant differences between a supply end and a demand end of the power grid; and with an increasing popularity of electric vehicles, charging demands of the electric vehicles are uncertain, exacerbating an imbalance between the supply end and the demand end of the power grid, thereby affecting reliability and stability of the power grid to supply power.

In recent years, demand response management (DRM) has been considered as an effective method to improve a running state of the power grid and to address the imbalance of the power grid. As an important department on the demand end of the power grid, a building energy system can change its power load curve in response to demands of the power grid, thus balancing the differences between the supply end and the demand end of the power grid, and eliminating instability of production capacity of distributed renewable energy sources. However, there are several critical issues on utilizing demand flexibilities of a building, the most important among which is to achieve an optimal scheduling on flexible resources. Furthermore, an air conditioning system is of great importance in a building energy system, so that when the demand response management is performed on the building energy system, the most important thing is to make full use of the flexibility of the air conditioning system.

However, a flexibility of an active energy storage strategy of the air conditioning system mainly depends on its water tank energy storage capacity, and a setting of day-ahead water tank energy storage capacity has a significant impact on demand response effect of daily running of the air conditioning system. Therefore, when considering an optimal scheduling strategy of the air conditioning system based on the demand response, how to fully consider a reasonable combination of various demand response strategies in a demand response stage during setting the water tank energy storage capacity in an energy storage phase is an important issue. However, optimization variables of the optimization problem are interrelated and have time sequencing, a commonly used single-level optimization structure is often difficult to achieve a desired optimization effect.

### SUMMARY

To solve the above-mentioned problem in the art, the disclosure provides a bi-level optimization scheduling method for an air conditioning system based on demand response. The method fully considers a reasonable combination of various demand response strategies in a demand response stage during setting a water tank energy storage capacity in an energy storage phase, so that a day-ahead water tank energy storage capacity matches a daily running strategy of the air conditioning system, realizing a global optimization of demand response scheduling strategy for the air conditioning system, making full use of a demand respond potential of the air conditioning system, and improving economy and energy saving of the system in operation.

In order to achieve the above objective, the disclosure provides a bi-level optimization scheduling method for an air conditioning system based on demand response, including the following steps:
step 1, constructing a lumped heat capacity model to describe a heat storage capacity of a building, thereby obtaining a building heat storage model;
step 2, based on the building heat storage model, obtaining a function relational expression of describing an indoor dry bulb temperature of the building and a cooling and heating load of the building;
step 3, based on the function relational expression, constructing a power consumption calculation model under a working condition of demand response;
step 4, based on the power consumption calculation model, constructing optimization objective functions; and
step 5, substituting the optimization objective functions into a bi-level optimization process, and optimizing the bi-level optimization process to obtain an optimal scheduling strategy for the air conditioning system participating in demand response. Moreover, in some embodiments, the bi-level optimization scheduling method further includes: scheduling the air conditioning system for the building under a demand response condition based on the optimal scheduling strategy.

In an embodiment, the lumped heat capacity model in the step 1 describes the heat storage capacity of the building in four aspects; and the four aspects include: a heat storage capacity of walls of an envelope structure of the building, a heat storage capacity of indoor air of the building, a heat storage capacity of partition walls, furniture, and roof thermal mass of the building and a heat storage capacity of an air conditioning water system.

In an embodiment, the step 2 includes: identifying parameters in the building heat storage model based on a Grey Wolf algorithm to obtain the function relational expression between the indoor dry bulb temperature of the building and the cooling and heating load of the building.

In an embodiment, the step 3 includes: based on the function relational expression, constructing a cooling and heating source component model, an active energy storage component model, a passive energy storage component model, and an accessory component model; and performing parameter identification and model integration on the cooling and heating source component model, the active energy storage component model, the passive energy storage component model and the accessory component model in sequence to obtain the power consumption calculation model.

In an embodiment, the optimization objective functions in the step 4 include: flexibility objective functions, a cost objective function, and an energy consumption objective function.

In an embodiment, the bi-level optimization includes: an upper-level optimization, which is an optimization of day-ahead water tank energy storage capacity of the air conditioning system, and a lower-level optimization, which is an optimization of daily running parameters of the air conditioning system.

The disclosure may achieve technical effects as follows.
1. Embodiments of the disclosure, through a bi-level structure of the bi-level optimization scheduling method and the setting of objective functions and the transferring of parameters between the upper and lower levels of the optimization algorithm, realize an optimal matching between the day-ahead water tank energy storage capacity of the air conditioning system and the daily running of the air conditioning system, and therefore, the economy and energy saving of system operation is improved under the premise of meeting a load reduction demand.
2. Embodiments of the disclosure, during using the lumped heat capacity model (i.e. RC model) to construct the heat storage capacity of a building, cover as comprehensively as possible all of components with heat storage capacity in the building and add a 1R1C branch (also referred to a branch with one resistor and one capacitor) to describe the heat storage capacity of the air conditioning water system; and meanwhile, perform reduced-order processing on branches of the external envelope structure and the internal thermal mass, and use a 3R1C branch to describe a heat transfer process of the envelope structure and a 1R1C branch to describe a heat transfer process of the internal thermal mass; thereby reducing the structural complexity of model and improving the stability of computing.
3. Embodiments of the disclosure focus on temporal characteristics in the demand response phase of the air conditioning system, proposes to quantify flexibility of the air conditioning system with an energy flexibility index and a power flexibility index, and gives a modeling method of the power consumption of the air conditioning system under demand response and a calculation method of the quantified flexibility indexes, thereby laying the foundation for efficient allocation and utilization of flexible resources of the air conditioning system.

### BRIEF DESCRIPTION OF DRAWINGS

In order to illustrate technical solutions in embodiments of the disclosure more clearly, the attached drawings used in the illustrated embodiments are briefly described below. Apparently, the attached drawings in the following description are some embodiments of the disclosure, and other drawings may be obtained from them without creative effort to those skilled in the art.

FIG. 1 illustrates a schematic flowchart of a bi-level optimization scheduling method for an air conditioning system based on demand response according to an embodiment of the disclosure.

FIG. 2 illustrates a schematic structural diagram of a RC model according to an embodiment of the disclosure.

FIG. 3 illustrates a schematic comparative diagram of calculation results of indoor temperature based on a building heat storage model according to an embodiment of the disclosure.

FIG. 4 illustrates a schematic comparative diagram of calculation results of cooling loads based on the building heat storage model according to the embodiment of the disclosure.

FIG. 5 illustrates a schematic comparative diagram of hour-by-hour electrical loads of the air conditioning system as per three optimization results according to an embodiment of the disclosure.

FIG. 6 illustrates a percentage radar diagram of demand response effects of the air conditioning system as per the three optimization results according to an embodiment of the disclosure.

### DETAILED DESCRIPTION OF EMBODIMENTS

The following will clearly and completely describe technical solutions in embodiments of the disclosure in combination with the attached drawings in the embodiments of the disclosure. Apparently, the described embodiments are only some of embodiments of the disclosure, not all of embodiments of the disclosure. Based on the described embodiments in the disclosure, all other embodiments obtained by those skilled in the art without creative effort fall within the scope of protection of the disclosure.

Embodiments of the disclosure will be exemplarily illustrated as follows.

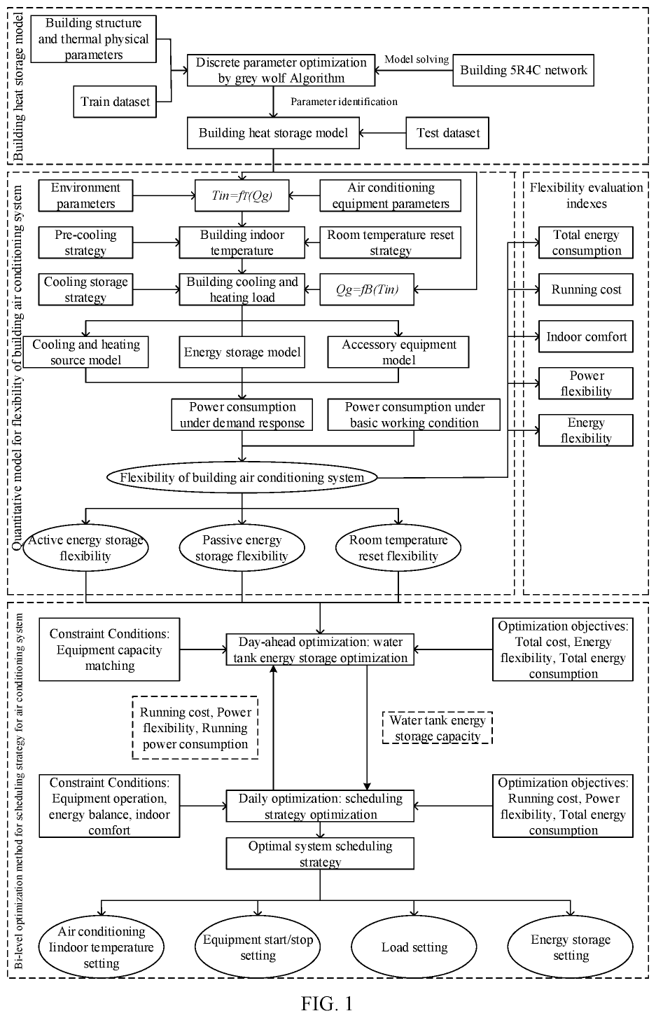

As shown in FIG. 1, an embodiment of the disclosure provides a bi-level optimization scheduling method for an air conditioning system based on demand response, including the following steps.

Step 1, a lumped heat capacity model is constructed to describe a heat storage capacity of a building, thereby obtaining a building heat storage model.

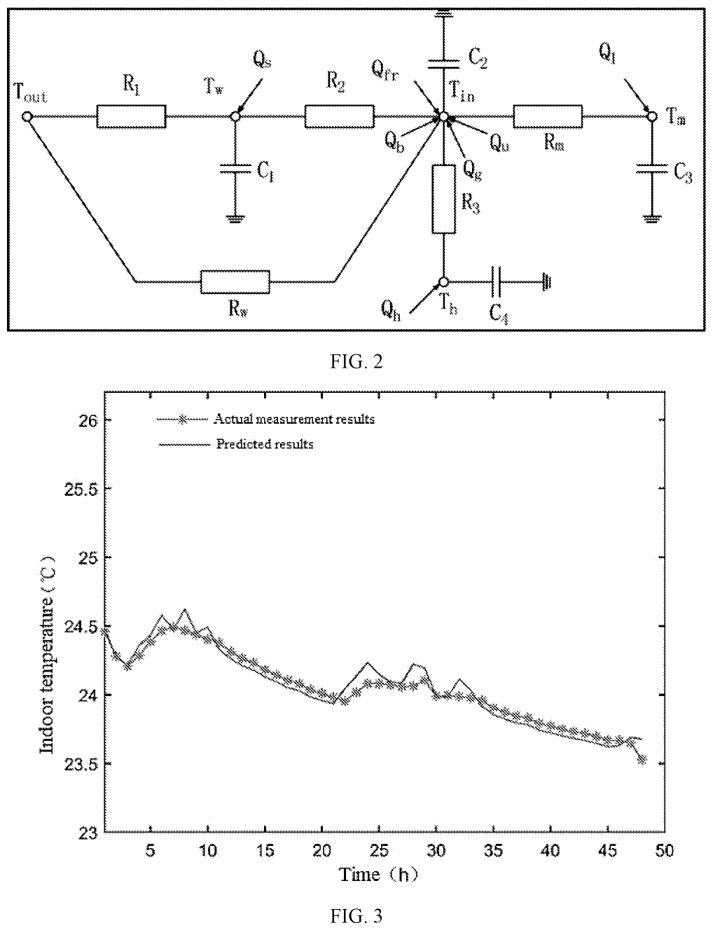

The lumped heat capacity model (i.e. Resistor-Capacitor (RC) model) is constructed according to heat transfer processes inside the building, including a 3R1C (referred to a branch with three resistors and one capacitors) heat storage model of an envelope structure of the building, a 1R1C (referred to a branch with one resistor and one capacitor) heat storage model of indoor thermal mass of the building, and a 1R1C (referred to a branch with one resistor and one capacitor) heat storage model of an air conditioning water system of the building; furthermore, a heat capacity of indoor air of the building is simplified as a capacitor (shown by C₂ in FIG. 2), thereafter obtaining the RC model. As shown in FIG. 2, the RC model in the embodiment of the disclosure is a 5R4C network model.

In the embodiment, the RC model describes the heat storage capacity of the building from four parts, including a heat storage capacity of walls of an envelope structure of the building, a heat storage capacity of the indoor air of the building, a heat storage capacity of partition walls, furniture, and roof thermal mass of the building and a heat storage capacity of the air conditioning water system of the building. Then, a virtual thermal network is respectively established to simulate each of the heat transfer processes of the above four parts, thereby obtaining the building heat storage model. The heat transfer processes of the above four parts of the building heat storage model can be expressed as follows.

The heat transfer process of the walls of the envelope structure of the building is expressed as follows:

$${Q}_{S} + \frac{{T}_{o u t} - {T}_{w}}{{R}_{1}} + \frac{{T}_{in} - {T}_{w}}{{R}_{2}} = {C}_{1} \frac{d {T}_{W}}{d t} ,$$

$${Q}_{w} = \frac{{T}_{out} - {T}_{i n}}{{R}_{w}} + {Q}_{l} ,$$

$${Q}_{1 , n} = α \times {A}_{1 , n} \times {I}_{s , n} , and$$

$${Q}_{1} = {Q}_{1 , n} + {Q}_{1 , w} + {Q}_{1 , s} + {Q}_{1 , e} .$$

In the formula, R₁ and R₂ represent equivalent thermal resistors for heat transfer of opaque exterior envelope structure of the building (with a unit of Kelvin temperature per kilowatt (K/kW)); T_{W} represents a temperature of a virtual node of the opaque exterior envelope structure of the building (with a unit of Celsius degree (° C.)); Q_{S} represents solar radiation heat absorbed by surfaces of the envelope structure (with a unit of kilowatt (kW)); C₁ represents an equivalent thermal capacitor of the opaque exterior envelope structure of the building (with a unit of kilojoule per Kelvin temperature (kJ/K)); Q_{W} represents heat entering indoor through transparent envelope structure (with a unit of kW); Q_{1,n} represents solar radiation heat transmitted by north transparent envelope structure of the building (with a unit of kW); Q₁ represents solar radiation heat transmitted by the transparent envelope structure of the building (with a unit of kW); R_{W} represents an equivalent thermal resistor for heat transfer of the transparent envelope structure of the building (with a unit of K/kW); Tₒᵤₜ represents a dry bulb temperature of an outdoor environment of the building (with a unit of ° C.); Tᵢₙ represents a volume average dry bulb temperature of indoor space of the building (with a unit of ° C.); α represents a transmittance of the transparent envelope structure of the building (%); A_{1,n} represents an area of the north transparent envelope structure of the building (with a unit of square meter (m²)); I_{s,n} represents solar radiation intensity perpendicular to the north transparent envelope structure of the building (with a unit of kW); and Q_{1,w}, Q_{1,s}, Q_{1,e} represent solar radiation heat transmitted by west transparent envelope structure, south transparent envelope structure and east transparent envelope structure of the building, the calculation methods for which are consistent with that of the north transparent envelope structure of the building (with a unit of kilowatt (kW)).

The heat transfer process of the inner thermal mass of the building is expressed as follows:

$${Q}_{l} + \frac{{T}_{i n} - {T}_{m}}{{R}_{m}} = {C}_{3} \frac{{dT}_{m}}{dt}$$

In the formula, Q₁ represents the solar radiation heat transmitted by the transparent envelope structure of the building (with a unit of kW); Tₘ represents a temperature of a node of the inner thermal mass of the building (with a unit of ° C.); Tᵢₙ represents the volume average dry bulb temperature of the indoor space of the building (with a unit of ° C.); Rₘ represents an equivalent thermal resistor for heat transfer of the indoor thermal mass of the building (with a unit of K/kW); C₃ represents an equivalent thermal capacitor of the inner thermal mass of the building (with a unit of kJ/K).

The heat transfer process of the air conditioning water system of the building is expressed as follows:

$${Q}_{h} + \frac{{T}_{i n} - {T}_{h}}{R 3} = {C}_{4} \frac{d {T}_{h}}{d t}$$

In the formula, Qₕ represents a heat supply capacity of the air conditioning system in the building (with a unit of kW); Tᵢₙ represents the volume average dry bulb temperature of the indoor space of the building (with a unit of ° C.); Tₕ represents a temperature of a virtual node of the air conditioning water system (with a unit of ° C.); R₃ represents an equivalent thermal resistor for heat transfer of a terminal equipment in the air conditioning system (with a unit of K/kW); C₄ represents an equivalent thermal capacitor of the air conditioning water system (with a unit of kJ/K).

The heat transfer process of the indoor air of the building is expressed as follows:

$$\frac{{T}_{w} - {T}_{i n}}{{R}_{2}} + \frac{{T}_{h} - {T}_{i n}}{{R}_{3}} + \frac{{T}_{m} - {T}_{i n}}{{R}_{m}} + \frac{{T}_{out} - {T}_{i n}}{{R}_{w}} + {Q}_{g} + {Q}_{f r} + {Q}_{u} + {Q}_{b} = {C}_{2} \frac{{dT}_{i n}}{d t}$$

$${T}_{i n} = \frac{{\sum }_{i = 1}^{k} {N}_{i} \times {T}_{i}}{k} .$$

In the formula, T_{w} represents the temperature of the virtual node of the opaque exterior envelope structure of the building (with a unit of ° C.); Tᵢₙ represents the volume average dry bulb temperature of the indoor space of the building (with a unit of ° C.); R₂ represents the equivalent thermal resistor for heat transfer of the opaque exterior envelope structure (with a unit of K/kW); Tₕ represents the temperature of the virtual node of the air conditioning water system (with a unit of ° C.); R₃ represents the equivalent thermal resistor for heat transfer of the terminal equipment in the air conditioning system (with a unit of K/kW); Tₘ represents the temperature of the node of the inner thermal mass of the building (with a unit of ° C.); Tₒᵤₜ represents the dry bulb temperature of the outdoor environment of the building (with a unit of ° C.); R_{w} represents the equivalent thermal resistor for heat transfer of the transparent envelope structure of the building (with a unit of K/kW); Q_{g} represents heat dissipation of personnel inside the building (with a unit of kW); Q_{fr} represents heat dissipation of indoor fresh air of the building (with a unit of kW); Qᵤ represents heat dissipation of indoor equipment of the building (with a unit of kW); Q_{b} represents heat dissipation of indoor lighting of the building (with a unit of kW); Nᵢ represents a volume of area i in the building (with a unit of cubic meter (m³)); Tᵢ represents a dry-bulb temperature of the area i in the building (with a unit of ° C.); K represents the number of the area i in the building.

Step 2, based on the building heat storage model, a function relational expression of describing an indoor dry bulb temperature of the building and a cooling and heating load of the building is obtained.

Based on the RC model, 70% of an actual measured dataset is used as a training dataset of the building heat storage model, and 30% of the actual measured dataset is used as a testing dataset. Parameters of the building heat storage model are identified by a Grey Wolf Optimization (GWO) Algorithm. Finally, the building heat storage model can be simplified as the function relational expression between the cooling and heating load and the indoor dry-bulb temperature expressed as follows:

Q_{j,t}=ƒ_{B}(a,T_{out,t},T_{in,t},T_{in,t-1},b,c,d), and

T_{in,t}=ƒ_{T}(a,T_{out,t},Q_{j,t},T_{in,t-1},b,c,d).

In the formula, Q_{j,t} represents a cooling and heating load of the building at a moment t (with a unit of kW); a represents the parameters of the building heat storage model after identification, including 5 equivalent thermal resistors (with a unit of K/kW) and 4 equivalent thermal capacitors (with a unit of kJ/K); T_{out,t} represents an outdoor dry bulb temperature of the building at the moment t (with a unit of ° C.); T_{in,t} represents an indoor dry bulb temperature of the building at the moment t (with a unit of ° C.); T_{in,t-1} represents an indoor dry bulb temperature of the building at a moment t−1 (with a unit of ° C.); b represents time parameters, including true solar time and date serial number; c represents internal disturbance parameters, including the number of the personnel, equipment power, lighting power, and per capita fresh air volume; ƒ_{B} ( . . . ) represents a calculation function of the building heat storage model for the cooling and heating load; and ƒ_{T} ( . . . ) represents a calculation function of the building heat storage model for the indoor temperature.

During identifying the parameters, based on actual factors such as thermal physical properties of materials of the envelope structure of the building, a water capacity and a terminal equipment form of the air conditioning system, and an indoor air capacity of the building in the embodiment, reasonable value ranges of the equivalent heat capacitors and the equivalent thermal resistors in the building heat storage model are restricted. The value ranges of the equivalent thermal resistors R₁, R₂, R₃, Rₘ, and R_{w} are respectively at a range of 0.02 K/kW to 0.8 K/kW, 0.1 K/kW to 0.8 K/kW, 0.00001 K/kW to 0.17 K/kW, 0.01 K/kW to 0.27 K/kW, and 0.01 K/kW to 0.5 K/kW. The value ranges of the equivalent thermal resistors C₂, C₃ and C₄ are respectively at a range of 10 KJ/K to 100 KJ/K, 0.8 KJ/K to 150 KJ/K and 0.2 KJ/K to 1000 KJ/K.

For optimization parameters of the grey wolf Algorithm, the number of the group is set to 120, and a maximum number of iteration is 500. After iterative calculation, the identification results of the GWO Algorithm for the building heat storage model are obtained. For the equivalent heat capacitors of R₁, R₂, R₃, Rₘ, and R_{w} are respectively 0.0326 K/kW, 0.153 K/kW, 0.0003 K/kW, 0.0189 K/kW, and 0.0457 K/kW; and the equivalent thermal resistors of C₂, C₃ and C₄ are respectively 22.75 KJ/K, 47.2 KJ/K, 1.1 KJ/K and 0.99 KJ/K.

In order to verify the accuracy of the calculation of the building heat storage model, the testing dataset is introduced into the building heat storage model, and the difference between the actual measured results and the calculated results of the building heat storage model is compared. Since the subsequent flexibility calculation of the air conditioning system requires that the building heat storage model can accurately calculate the indoor temperature and the cooling capacity of the building at the same time, so that, firstly, under the same cooling capacity conditions, the actual measured indoor temperature and the indoor temperature calculation results based on the building heat storage model are compared to verify the accuracy of the building heat storage model in the indoor temperature calculation, and the comparison of the calculation results in 48 hours is illustrated in FIG. 3. The comparison results show that the indoor temperature calculated by the building heat storage model is basically consistent with the actual measured results. In an accuracy evaluation index of the obtained model, a correlation coefficient R² of the model reached 90.8%, indicating that the calculation results of the model have a good following ability to the testing results. It can be considered that the calculation of the indoor temperature using the building heat storage model is accurate.

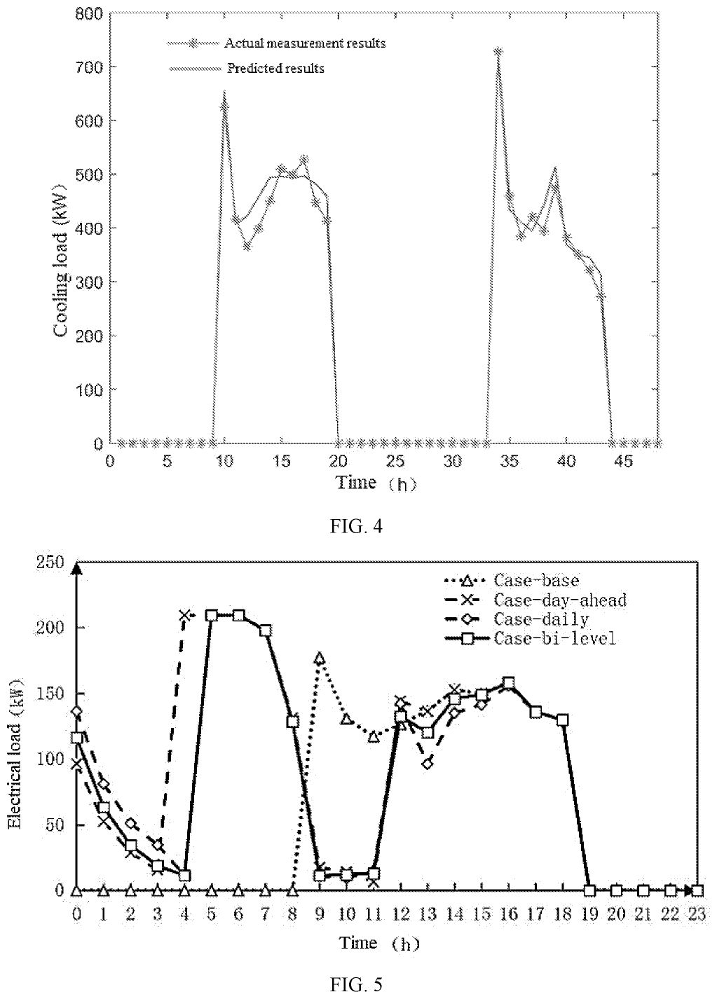

In addition, in order to verify the accuracy of the cooling load calculation of the building heat storage model, under the same change conditions of the indoor temperature, the actual measured cooling load of the building is compared with the cooling load calculated by the building heat storage model, and the calculation results of 48 h are illustrated in FIG. 4. Compared with a calculation error for the indoor temperature, a calculation error for the cooling load of the building heat storage model is relatively large, but it can basically reflect the change trend of the cooling load of the building. In an evaluation index of the building heat storage model, CV-RMSE (referred to a root mean square error of Circulation Volume) reaches 3.5%; while in a load forecast, CV-RMSE is less than 30%, which is regarded as an accurate prediction, so that it can be considered that the calculation of cooling load of the building heat storage model is accurate.

Step 3, based on the function relational expression obtained in the step 2, a power consumption calculation model under a working condition of demand response is constructed.

Based on the function relational expression obtained in the step 2, a cooling and heating source component model, an active energy storage component model, a passive energy storage component model, and an accessory component model are constructed. Parameter identification and model integration are respectively performed on the cooling and heating source component model, the active energy storage component model, the passive energy storage component model, and the accessory component model in sequence to obtain the power consumption calculation model of the air conditioning system under different working conditions of demand response.

A performance model of an air conditioning unit needs to be regressed. In the embodiment, the regression operation adopts a temperature correlation model, and uses a linear relationship between a reciprocal of a cooling loading capacity of the air conditioning unit (1/Q) and a reciprocal of a performance coefficient (1/cop) of the air conditioning unit to construct a relationship between the performance coefficient of the air conditioning unit and an evaporator inlet temperature of the air conditioning unit, the cooling loading capacity of the air conditioning unit and a condenser inlet temperature of the air conditioning unit. And the linear relationship is expressed as follows:

$$c o p = \frac{1}{( {a}_{1} \times \frac{{T}_{e}}{Q} + {a}_{2} \times \frac{{T}_{c} - {T}_{e}}{Q} + 1 ) \times \frac{{T}_{c}}{{T}_{c} - {a}_{3} \times Q} - 1}$$

In the formula, a₁, a₂ and a₃ represent parameters of the performance model of the air conditioning unit; Tₑ represents the evaporator inlet temperature of the air conditioning unit (with a temperature of ° C.); Tₑ represents the condenser inlet temperature of the air conditioning unit (with a temperature of ° C.); Q represents the cooling loading capacity of the air conditioning unit (with a unit of kW).

According to actual measured cooling loading capacity and power consumption of a heat pump unit, a performance curve of the heat pump unit is fitted by a least square method to obtain the power consumption calculation model. And the power consumption calculation model is expressed as follows:

$$c o p = \frac{1}{( 1.678 \times \frac{{T}_{e}}{Q} - 4.3356 \times \frac{{T}_{c} - {T}_{e}}{Q} + 1 ) \times \frac{{T}_{c}}{{T}_{c} - 0.00182 \times Q} - 1}$$

Through verifying an accuracy of the power consumption calculation model, R² (referred to a correlation coefficient) reaches 92.3%, indicating that the fitted power consumption calculation model can accurately reflect the performance variations of the air conditioning unit.

The cooling and heating source component model is constructed as follows.

The air conditioning unit consumes electric power by taking heat from a low temperature heating source and releasing heat to a high temperature heating source. The cooling and heating load capacity and the power consumption of the air conditioning unit can be calculated by the following formula:

$${Q}_{j z , t} = 4.2 \times {G}_{j z , t} \times ( {T}_{h , t} - {T}_{g , t} ) \div 3.6 , and$$

$${E}_{j z , t} = \frac{{Q}_{jz , t}}{c o {p}_{t}} .$$

In the formula, Q_{jz,t} represents a cooling and heating load capacity borne by the air conditioning unit at a moment t (with a unit of kW); G_{jz,t} represents a chilled water flow of the air conditioning unit at the moment t (with a unit of cubic meter per hour (m³/h)); T_{h,t} represents a return water temperature of the air conditioning unit at the moment t (with a unit of ° C.); T_{g,t} represents a water effluent temperature of the air conditioning unit at the moment t (with a unit of ° C.); E_{jz,t} represents energy consumption of the air conditioning unit at the moment t (kW); copₜ represents a performance coefficient of the air conditioning unit at the moment t.

The active energy storage component model (also referred to a water tank capable of storing energy) is constructed as follows.

A typical representative of the active energy storage component model is that the air conditioning system uses the water tank for ice cooling storage or water cooling storage to realize heat transfer, and uses a cooling storage capacity of the cooling storage water tank to store cooling in a valley power phase and release the cooling in a peak power phase, thereby meeting or partially meeting the cooling and heating load requirements of the building in the peak power phase.

Energy release process of the water tank is achieved by the following formulas:

$${Q}_{f , t} = min \{ \begin{matrix}4.2 \times {G}_{f , t} \times ( {T}_{h , t} - {T}_{g , t} ) \div 3.6 \\ {Q}_{sy , t}\end{matrix}$$

$${T}_{g , t} = {T}_{f , min} + Δ {T}_{x} \times \frac{{Q}_{sy , t}}{{Q}_{x , z}}$$

$${Q}_{s y , t} = ( {Q}_{s y , t - 1} - {Q}_{f , t - 1} ) \times Δ t$$

In the formula, Q_{ƒ,t} and Q_{ƒ,t-1} represent energy release of the energy storage water tank at a moment t and a moment t−1 (with a unit of kW); G_{ƒ,t} represents a flow of an energy release pump at the moment t (with a unit of m³/h); T_{h,t} represents a water inlet temperature of the energy storage water tank at the moment t (with a unit of C); T_{g,t} represents a water outlet temperature of the energy release of the energy storage water tank at the moment t (with a unit of C); Q_{sy,t}, and Q_{sy,t-1} represent remaining cooling loads of the energy storage water tank at the moment t and the moment t−1 (with a unit of kJ); T_{ƒ,min} represents a minimum energy storage temperature of the energy storage water tank (with a unit of ° C.); ΔTₓ represents a setting temperature difference of the energy storage water tank (with a unit of ° C.); Q_{x,z} represents a setting energy storage capacity of the energy storage water tank (with a unit of kJ); and Δt represents a time interval (with a unit of h) for the energy release.

Energy storage process of the water tank is achieved by the following formula:

$${Q}_{x , t} = min \{ \begin{matrix}4.2 \times {G}_{x , t} \times ( {T}_{h , t} - {T}_{g , t} ) \div 3.6 \\ {Q}_{f , z} - {Q}_{sy , t} \\ {Q}_{jz , z}\end{matrix}$$

In the formula, Q_{x,t} represents an energy storage capacity of the energy storage water tank at a moment t (with a unit of kW); G_{x,t} represents a flow of an energy storage pump at the moment t (with a unit of m³/h); T_{h,t} represents the water inlet temperature of the energy storage water tank at the moment t (with a unit of C); T_{g,t} represents the water outlet temperature of the energy release of the energy storage water tank at the moment t (with a unit of C); Q_{sy,t} represents the remaining cooling load of the energy storage water tank at the moment t (with a unit of kJ); Q_{jz,z} represents a rated cooling (heating) load capacity of the air conditioning unit (with a unit of kW); Q_{ƒ,z} represents a maximum cooling storage capacity of the energy storage water tank (with a unit of kJ).

The passive energy storage component model is constructed as follows.

The above type of component model refers to using energy storage capacities of the envelope structure of the building, the indoor furniture and the indoor air to realize the heat transfer and using thermal inertia in the building to reduce the indoor temperature by precooling or preheating the building in advance in the valley power phase, thereby reducing the cooling and heating load requirements of the building in the peak power phase. The passive energy storage component model focuses on describing the cooling and heating load that it reduces or transfers when participating in the demand response, which can be calculated by building load simulation software (white box model) or the lumped heat capacity model (gray box model). And the calculation process is expressed as follows:

Q_{B,t}=ƒ_{B}(a,T_{out,t},T_{in,t},Tₛ,b,c,d)−Q_{j,t}=ƒ_{B}(a,T_{out,t},T_{s,t},T_{s,t-1},b,c,d)

In the formula, Q_{B,t} represents a cooling and heating load that can be reduced by the passive energy storage component at a moment t (with a unit of kW); ƒ_{B}( . . . ) represents the calculation function of the building heat storage model for the cooling and heating load; Tₛ represents a setting indoor temperature at the demand response phase (with a unit of ° C.); T_{s,t} represents an indoor temperature under a working condition of a moment t (with a unit of ° C.); and T_{s,t-1} represents an indoor temperature under a working condition of a moment t−1 (with a unit of ° C.).

The accessory component model is constructed as follows.

The accessory components in the air conditioning system refer to the components facilitating the normal operation of the air conditioning system, such as water pumps that provide circulating power, a cooling tower that dissipates heat to the environment, etc. Most of the accessory components operate at fixed frequency and are interlocked with critical equipment in the system to start and stop.

Water pump power consumption: the accessory component model calculates the water pump power consumption of the air conditioning system according to an electricity consumption to cooling (heating) ratio (EC(H)R) expressed as follows:

$$ECR = \frac{A \times ( B + ∝ \times \sum L )}{Δ t}$$

$${E}_{p , t} = E C R \times {Q}_{p , t}$$

In the formula, ECR represents the electricity consumption to cooling ratio of the water pump of the air conditioning system; A represents a calculation coefficient related to a flow of the water pump, which is selected according to an international standard (GB 50736-2012); B represents a calculation coefficient related to a machine room and user water resistance; ∝ represents a calculation coefficient related to ΣL; ΣL represents a total transmission length of a supply and return water pipeline from the machine room to a farthest user of the air conditioning system (with a unit of m); ΔT represents a temperature difference between supply and return water of the air conditioning system (with a unit of ° C.); E_{p,t} represents a power consumption of the water pump of the air conditioning system (with a unit of kW); and Q_{p,t} represents cooling and heating load delivered by the water pump (with a unit of kW).

Cooling tower power consumption: cooling towers are assumed to operate at a fixed frequency in the accessory component model, and the cooling tower power consumption is calculated by a formula as follows:

E_{ct,t}=nsₜ×E_{ct,s}.

In the formula, E_{ct,t} represents a total power of cooling towers at a moment t (with a unit of kW); nsₜ represents the number of the cooling towers running at the moment t (with a unit of set); E_{ct,s} represents a rated power of the cooling towers (with a unit of kW).

Step 4, optimization objective functions are constructed based on the power consumption calculation model.

The power consumption calculation model of the air conditioning system obtained from the step 3 is used to calculate the power consumption of the air conditioning system under a basic working condition without participating in the demand response, and to respectively construct calculation formulas of the optimization objective functions in the optimization process, including flexibility objective functions (referred to an energy flexibility objective function ƒ_{ƒ}, a power flexibility objective function ƒ_{w}), a cost objective function ƒ_{c}, and an energy consumption objective function ƒₑ.

The flexibility objective functions are constructed as follows.
(1) A pre-cooling temperature, a pre-cooling time and a rated cooling load of the air conditioning system are brought into the indoor temperature calculation function (ƒ_{T}) of the building heat storage model, and an indoor temperature of the building in non-working hours is calculated under a condition that the cooling and heating load of the building is equal to 0. Under a condition that the air conditioning system operates at full load, an indoor temperature of the building during the pre-cooling (pre-heating) phase is calculated. The indoor temperature of the building during the pre-cooling (pre-heating) phase is combined with a setting indoor temperature during working hours to obtain an indoor temperature change curve of the building based on the demand response.

A calculation formula at the non-working hours is expressed as follows: Tᵢₙ, =ƒ_{T}(a, T_{out,t}, 0, T_{in,t-1},b, c, d), and in the formula, the cooling and heating load of the building is equal to 0.

A calculation formula at the pre-cooling phase is expressed as follows: T_{in,t}=ƒ_{T}(a, T_{out,t},Q_{jz,t}, T_{in,t-1}, b, c, d), and in the formula, the cooling and heating load of the building is equal to Q_{jz,t}.

A calculation formula at the working hours is expressed as follows:

T_{in,t}=Tₛ, and in the formula, T_{in,t-1} represents an indoor temperature at a moment t−1, and the indoor temperature of the building needs to be calculated iteratively (with a unit of ° C.).
(2) The cooling and heating load of the building is calculated by using the passive energy storage component model and the indoor temperature curve constructed in the step 3 based on the demand response, which is expressed as follows:

Q_{B,t}=ƒ_{B}(a,T_{out,t},T_{in,t}Tₛ,b,c,d).
(3) The energy storage strategy is introduced into the constructed cooling and heating source component model, the accessory component model, and the energy storage component models (including the active energy storage component model and the passive energy storage component model) to calculate the power consumption of the air-conditioning system under the premise that the cooling and heating load of the building meets the building demand response. Therefore, the difference between the calculated power consumption and the power consumption of the air-conditioning system under the basic working condition is an amount of electrical loads that the air-conditioning system can reduce or transfer. And the calculation formula is expressed as follows:

$$\begin{matrix}{E}_{d , t} = \frac{{Q}_{B , t} - {Q}_{f , t}}{c o {p}_{t}} + {E}_{p , t} + {E}_{w , t} \\ {f}_{s , t} = {E}_{s , t} - {E}_{d , t} .\end{matrix} ,$$

In the formula, E_{d,t} represents the power consumption of the air conditioning system participating in the demand response at a moment t (with a unit of kW); Q_{B,t} represents the cooling and heating load that can be reduced by the passive energy storage component model at the moment t (with a unit of kW); Q_{ƒ,t} represents the energy release of the energy storage water tank at the moment t (with a unit of kW); copₜ represents the performance coefficient of the air conditioning system at the moment t; E_{p,t} represents power consumption of the water pump in the air conditioning system at the moment t (with a unit of kW); E_{s,t} represents the power consumption of the air conditioning system under the basic working condition at the moment t (with a unit of kW); E_{w,t} represents the power consumption of the cooling tower (with a unit of kW).
(4) On the basis of the above power flexibility calculation, the energy flexibility objective function ƒ_{ƒ} of the air conditioning system is an integral of the power reduction amount over time in the calculation period, and the power flexibility objective function ƒ_{w} is an average value of the electric power reduction amount in the calculation period. The calculation formulas are as follows:

$${f}_{f} = {\sum }_{t = 1}^{T} {f}_{s , t} ,$$

and in the formula, ƒ_{ƒ} represents the energy flexibility objective function of the air conditioning system (with a unit of kilowatt hour (kWh); and ƒ_{s,t} represents an electrical power transferred or reduced by the air conditioning system at a moment t (with a unit of kW); and
ƒ_{w}=ƒ̅_̅{̅s̅,̅t̅}̅, and in the formula, ƒ_{w} represents the power flexibility objective function of the air conditioning system (with a unit of kW).

The cost objective function ƒ_{c} is constructed as follows:

$${f}_{c} = min ( {C}_{s t o r a g e} + {C}_{r u n} ) ,$$

$${C}_{s t o r a g e} = {\sum }_{t = 1}^{L} {\sum }_{i = 1}^{z} {\sum }_{k = 1}^{e} ( {c}_{k , t} \times {E}_{i , k , t} ) , and$$

$${C}_{run} = {\sum }_{t = 1}^{H} {\sum }_{i = 1}^{z} {\sum }_{k = 1}^{e} ( {c}_{k , t} \times {E}_{i , k , t} ) .$$

In the formula, L represents a demand response time of the air conditioning system (with a unit of h); H represents a time for the energy storage of the air conditioning system (with a unit of h); ƒ_{c} represents the objective function of the cost (with a unit of rmb ‘yuan’); Cᵣᵤₙ represents a running cost of the air conditioning system (with a unit of rmb ‘yuan’); C_{storage} represents a cost of the energy storage of the air conditioning system (with a unit of rmb ‘yuan’); c_{k,t} represent a unit price (yuan/kWh) of consumed category k energy at a time t; E_{i,k,t} represents energy consumption of a Class i equipment of the air conditioning system in the category k energy at the time t (kWh); z represents the number of the equipment; e represents the number of categories of energy; K represents the category k energy; i represents the Class i equipment.

The objective function of the energy consumption ƒₑ is constructed as follows:

$${f}_{e} = min ( {\sum }_{t = 1}^{T} {\sum }_{k = 1}^{e} {E}_{t , k} ) .$$

In the formula, ƒₑ represents the objective function of the energy consumption (with a unit of kWh); E_{t,k}, represents an amount of the category k energy consumed by the air conditioning system at the time t hour (with a unit of kWh).

Step 5, the optimization objective functions are substituted into a bi-level optimization process and the bi-level optimization process is optimized to obtain an optimal scheduling strategy for the air conditioning system participating in demand response. Furthermore, in some embodiments, the bi-level optimization scheduling method further includes: scheduling the air conditioning system for the building under a demand response condition based on the optimal scheduling strategy.

The constructed objective functions are brought into a bi-level optimization structure. An upper-level optimization of the bi-level optimization structure is an optimization of day-ahead water tank energy storage capacity of the air conditioning system, and a minimum cost ƒₑ, a minimum energy consumption ƒₑ and a maximum energy flexibility ƒ_{ƒ} are used as optimization objectives to optimize the water tank energy storage capacity V in the energy storage phase under a condition of satisfying the equipment capacity constraint. A lower-level optimization is an optimization of daily running parameters of the air conditioning system, and the lower-level optimization takes objectives of the system running cost Cᵣᵤₙ, the energy consumption ƒₑ and the power flexibility ƒ_{w} into account to optimize the start/stop and power output of each equipment in the system while satisfying the capacity constraint, energy balance constraint and comfort constraint of each equipment.

A genetic algorithm and multi-objection decision-making method are used to solve and optimize the constructed bi-level optimization structure. During the optimization process, the day-ahead optimization results (energy storage V) become the constraint condition of the optimization process of the daily running parameters, while the running cost of the air conditioning system Cᵣᵤₙ, the energy consumption ƒₑ and the power flexibility ƒ_{w} generated after the optimization of the daily running parameters feeds back the calculation of the day-ahead optimization objective, and readjusts the water tank energy storage V of in the day-ahead optimization process. The optimization parameters between the upper and lower levels are transferred to each other, and finally the optimal allocation between the day-ahead water tank energy storage capacity of the air conditioning system and the daily running of the air conditioning system is achieved to obtain the optimal scheduling strategy of the air conditioning system based on the demand response.

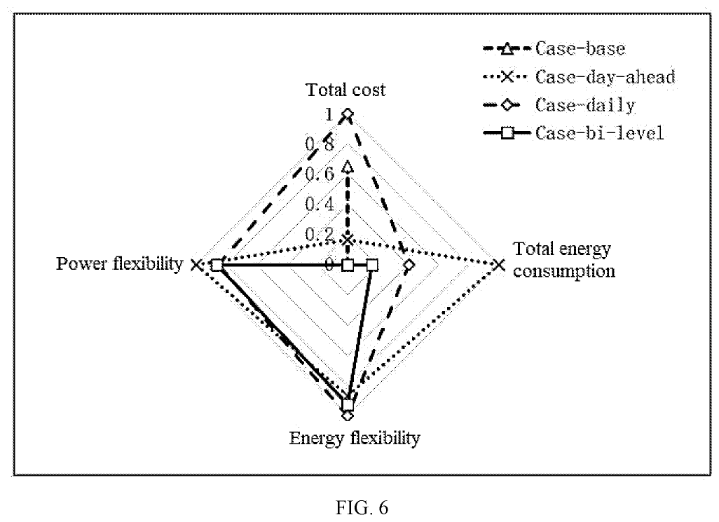

The bi-level optimization scheduling method provided by the disclosure is compared with the optimization results of conventional single-level optimization scheduling methods to reflect its advantages. Namely, the optimization calculation is performed on the scheduling strategies for the air conditioning system based on the demand response under three methods of the conventional day-ahead water tank energy storage (referred to Case-day-ahead shown in FIGS. 5-6), daily running parameters (referred to Case-daily shown in FIGS. 5-6) and the bi-level optimization (referred to Case-bi-level shown in FIGS. 5-6) respectively to obtain the optimization results. The optimization results are as follows.

For the single-level optimization strategy of the day-ahead water tank energy storage capacity, the optimized water tank energy storage capacity is 897 kWh under a premise of setting the pre-cooling time of 5 h, the pre-cooling temperature of 22° C. and the average absolute temperature deviation of 1.2° C. For the single-level optimization strategy of the daily running parameters, the pre-cooling time is 4 h, the pre-cooling temperature is 23° C., and the average absolute temperature deviation of temperature reset is 1.3° C. under a premise of setting the day-ahead water tank energy storage capacity of 1200 kWh. However, for the bi-level optimization scheduling strategy proposed by the disclosure, the optimized water tank energy storage capacity is 1037 kWh, the precooling time is 4 h, the precooling temperature is 23° C., and the average absolute temperature deviation of temperature reset is 1.3° C.

Therefore, based on the optimization results of the above three scheduling strategies for the air conditioning system, in order to analyze the differences in the working conditions of the system before and after the change of the water tank energy storage capacity, the hour-by-hour electric loading of the system needs to be further compared among the three scheduling strategies, as shown in FIG. 5. It can be seen from FIG. 5 that under the strategy of Case-day-ahead, the air conditioning system runs under the maximum power flexibility. At this time, 8 units in the air condition unit start up 5 hours in advance (at 3:00 am) and continue to run, precooling the building to the setting temperature of 22° C., and combining the active energy storage and indoor temperature reset to transfer the electric loading of 91% of the peak electricity price period (at 8:00 am to 11:00 am). At this time, the units in the air conditioning system are closed, and the requirement of the cooling load of the building can be satisfied only by the energy release of the water tank, achieving a relatively good demand response effect. However, it is worth noting that when the Case-bi-level strategy considers the optimal daily running for the air-conditioning system during setting the day-ahead water tank energy storage capacity, the optimization scheduling strategy makes the air conditioning unit only need to start up 4 hours in advance and pre-cool the building to 23° C., achieving 91.4% of the peak electric loading transfer, which illustrated the better electric loading transfer ability than that of the Case-day-ahead strategy. The above mainly due to that the bi-level optimization scheduling strategy uses the active energy storage strategy with higher energy storage efficiency to partially replace the passive energy storage strategy with extremely low energy storage efficiency by reasonably improving the water tank energy storage capacity, thereby making the air-conditioning system show better economy and energy saving under the premise of having the same electric loading transfer capacity.

However, comparing the running state of the air-conditioning system under the Case-daily strategy and the Case-bi-level strategy in FIG. 5, the performance between the two optimization scheduling strategies in the system running phase is not significantly different. At 4:00 am to 12:00 pm and 16:00 pm to 23:00 pm, the electric loadings of the air conditioning system under the two scheduling strategies are basically the same, while the difference in setting the day-ahead water tank energy storage capacity makes the electric loading of the air conditioning system in the energy storage phase increase 30.1%, and the electric loading reduction in the energy release phase increase 7.8% in the Case-daily strategy; however, it is worth noting that the transferred electric loading is located in the flat price period from 12:00 pm to 17:00 pm, reflecting the economic benefit of the loading transfer is very low, thereby increasing the running cost of the air conditioning system by 1.4%. It shows that the bi-level optimization scheduling method can make full use of the demand response potential of the energy storage equipment, effectively use the day-ahead water tank energy storage capacity and improve the economy and energy saving while running the system.

In summary, it is found that compared with the single-level optimization scheduling methods, the bi-level optimization scheduling method can achieve the reasonable allocation between the day-ahead water tank energy storage capacity and the daily running parameters of the system, and fully tap the demand response potential of the energy storage equipment. Furthermore, the bi-level optimization scheduling method ensures the optimization scheduling of the demand response strategies by setting the reasonable water tank energy storage capacity, improves the economy and energy saving while running the system, and has no significant impact on the electric loading transfer of the system.

Finally, in order to more intuitively illustrate the beneficial effects of the bi-level optimization scheduling method, four properties of the air conditioning system including the total cost, the total energy consumption, the energy flexibility and the power flexibility, are compared under the above three optimization scheduling strategies. Furthermore, the radar diagram of the four properties based on the demand response is illustrated according to the calculation results, as shown in FIG. 6. A variety of indexes are normalized during illustrating the radar diagram, so that it can be simply understood in FIG. 6 that the closer to the number 1, the larger the index is, and the closer to 0, the smaller the index is. It can be seen from FIG. 6 that the bi-level optimization scheduling method illustrates obvious economy and energy efficiency advantages because it realizes the reasonable allocation between the day-ahead water tank energy storage capacity and the daily running parameters. The total cost and the total energy consumption of the air conditioning system are 1.7% and 15.9% lower than that of the conventional Case-day-ahead scheduling method, and 9.6% and 13.8% lower than that of the conventional Case-daily scheduling method. In terms of the flexibilities, the bi-level optimization scheduling method has no significant impact on the energy flexibility and power flexibility of the system. Compared with the maximum values under the three optimization scheduling methods, the power flexibility and the energy flexibility reduce no more than 10%. Therefore, in the aspect of the optimization scheduling for the air conditioning system, the bi-level optimization scheduling method can achieve better demand response effect than the single-level optimization scheduling method, indicating significant advantages.

The above display and description only describe basic principles, main features and advantages of the disclosure. Those skilled in the art should understand that the disclosure is not limited by the above described embodiments. The above described embodiments and the specification only describe the principle of the disclosure. Without departing from the spirit and scope of the disclosure, there will be various changes and improvements in the disclosure. These changes and improvements fall within the protection scope of the disclosure. The protection scope of the disclosure falls within the described embodiments of the disclosure and their equivalent replacements.

What is claimed is:

1. A bi-level optimization scheduling method for an air conditioning system based on demand response, comprising following steps:
step 1, constructing a lumped heat capacity model to describe a heat storage capacity of a building, thereby obtaining a building heat storage model;
step 2, based on the building heat storage model, obtaining a function relational expression of describing an indoor dry bulb temperature of the building and a cooling and heating load of the building;
step 3, based on the function relational expression, constructing a power consumption calculation model under a working condition of demand response;
step 4, based on the power consumption calculation model, constructing optimization objective functions; and
step 5, substituting the optimization objective functions into a bi-level optimization process, and optimizing the bi-level optimization process to obtain an optimal scheduling strategy for the air conditioning system participating in demand response; and
further comprising: scheduling the air conditioning system for the building under a demand response condition based on the optimal scheduling strategy.

2. The bi-level optimization scheduling method for an air conditioning system based on demand response according to claim 1, wherein the lumped heat capacity model in the step 1 describes the heat storage capacity of the building in four aspects; and
the four aspects comprise: a heat storage capacity of walls of an envelope structure of the building, a heat storage capacity of indoor air of the building, a heat storage capacity of partition walls, furniture and roof thermal mass of the building, and a heat storage capacity of an air conditioning water system.

3. The bi-level optimization scheduling method for an air conditioning system based on demand response according to claim 1, wherein the step 2 comprises:
identifying parameters in the building heat storage model based on Grey Wolf algorithm to obtain the function relational expression between the indoor dry bulb temperature of the building and the cooling and heating load of the building.

4. The bi-level optimization scheduling method for an air conditioning system based on demand response according to claim 1, wherein the step 3 comprises:
based on the function relational expression, constructing a cooling and heating source component model, an active energy storage component model, a passive energy storage component model, and an accessory component model; and
performing parameter identification and model integration on the cooling and heating source component model, the active energy storage component model, the passive energy storage component model, and the accessory component model in sequence to obtain the power consumption calculation model.

5. The bi-level optimization scheduling method for an air conditioning system based on demand response according to claim 1, wherein the optimization objective functions in the step 4 comprise:
flexibility objective functions, a cost objective function, and an energy consumption objective function.

6. The bi-level optimization scheduling method for an air conditioning system based on demand response according to claim 1, wherein the bi-level optimization process comprises:
an upper-level optimization, which is an optimization of day-ahead water tank energy storage capacity of the air conditioning system, and
a lower-level optimization, which is an optimization of daily running parameters of the air conditioning system.
